(19) United States
(12) Patent Application Publication
(10) Pub. No.: US 2003/0186572 A1
(43) Pub. Date: Oct. 2, 2003

(54) Self compensating design for elastomer interconnects

(76) Inventors: Gareth Geoffrey Hougham, Ossining, NY (US); Claudius Feger, Poughkeepsie, NY (US)

Correspondence Address: Alvin J. Riddles, Box 34, Candlewod Isle, New Fairfield, CT, 06812, US

(21) Appl. No.: 10/112,900

(22) Filed: Apr. 1, 2002

(51) Int. Cl. H01R 4/58

(52) U.S. Cl. 439/91

(57) ABSTRACT

In the invention the various effects of temperature and responsiveness in the technology is moderated in the resulting interconnect structure by building into the supporting frame arrangement a selected thermal expansion property that operates to exert some control on the thermal dimensional aspects of the elastomeric interconnect in its' fabrication and throughout its' service. In accordance with the invention the materials involved in the interconnect and frame are at least partially provided with a selected coefficient of thermal expansion (CTE) property that provides a direction and magnitude aspect in the structure that operates to compensate for dimensional changes to the interconnects that may occur to the array in fabrication and service.

### FIELD OF THE INVENTION

The invention relates to high density electronic interconnections in large arrays of very small devices such as the land grid array (LGA) type in the art and in particular to a structure and method of imparting high density with reliability to arrays of metal filled elastomer interconnects known in the art as metal-polymer interposers (MPI).

### BACKGROUND OF THE INVENTION

In the LGA technology, large area rasters or two dimensional arrays of elastomeric contact member elements, each made of a resilient material such as a composite of siloxane elastomer which is impregnated or filled with conductive silver particles, each form an electrical column shaped interconnection between an input output pad on a contact plane surface of a modular structure including an integrated circuit chip element member and a vertically arranged input output contact location on a surface of a printed circuit board member.

Each elastomeric contact member provides good electrical conductivity as long as the column remains in compression and in the presence of an opposite direction restoring force that is provided by the compressed elastomer material. The LGA technology has the promise of providing, spacially close to each other, large area, reliable, and steady contacting connections, with those connections, as an array, being readily attached and detached.

As the LGA technology is developing, dimensional and pressure control of the array is taking on increasing importance. In the art the fabrication is evolving to where the elastomeric contact members are carried on a supporting frame arrangement that in general provides separation dimension setting members at selected places in the array raster, and at selected locations at the edge of the array, compression stop members known in the art as downstops are positioned so that as the integrated circuit chip and the printed circuit board are compressed toward each other, the elastomeric interconnect members are to deform until the integrated circuit material reaches the downstop location which then establishes a selected value two direction gap, of elastomer contact area and a select initial quantity of an opposing pressure to the compression pressure across each elastomeric contact member. In the technology, many of the specifications of the elements involved are interrelated and involve tradeoff considerations. For dimensional perspective, elastomeric interconnect members in the range of less than 0.5 millimeter diameter and less than 30 mils in length are being approached.

The state of the art is generally described in the publication titled “An Investigation on the Mechanical Behavior of Elastomer Interconnects” by Jingsong Xie et al, in Proceedings of the 1999 International Symposium on Microelectronics, Pages 58-63; pointing out in general that there are many structural and environmental factors that can influence elastomeric contact quality and illustrating the handling of arrays of interconnects in a thin plastic sheet. Land Grid Arrays of elastomeric contacts sometimes called buttons or collectively as metal polymer interposers in the art, when mounted in a border frame, are available from manufacturers such as Thomas and Betts and Tyco.

A need is developing in the art for an elastomeric interconnection technology wherein there is reduced effect of the variables and tradeoffs that affect quality of the contacts, yield in manufacturing and durability in service. As specific illustrations, over long periods of time and during the course of temperature fluctuations, the restoring force in turn fluctuates and often results in electrical discontinuities.

### SUMMARY OF THE INVENTION

In the invention the various effects of temperature and responsiveness in the technology is moderated in the resulting interconnect structure by building into the individual elastomeric interconnect members and into the grid array arrangement and supporting frame a selected thermal expansion property that operates to exert some control on the thermal dimensional aspects of the elastomeric interconnect array as it is being fabricated and throughout subsequent service, including temperature variations during that service. In accordance with the invention in the frame there is provided a selected coefficient of thermal expansion (CTE) property that operates to compensate for dimensional changes that may occur in fabrication and service.

### BRIEF DESCRIPTION OF THE DRAWINGS

FIGS. 1, 2a, 2b, 2c and 3 are cross sectional depictions of the details of the elements in the electrical interface that are considerations in the invention, wherein;

FIG. 1 is a cross sectional depiction, with the compression and restore forces represented by arrows, of a single contact pad portion of the interface of superimposed input output pads connected by an elastomer interconnect member; and,

FIGS. 2a, 2b and 2c are cross sectional depictions of the electrical contact of the elastomer interconnect members in the invention, before and after, a dimensional pullback of the elastomer material of the interconnect members.

FIG. 3 is a cross sectional depiction of a modular structure having single or multiple integrated circuit members interconnected on an intermediate member of ceramic type material in turn connected to a printed wiring type board through the elastomer interconnect members of the invention.

FIG. 4 is a cross sectional depiction of a partially assembled cross sectional view of an exemplary two, side by side, elastomer interconnect members positioned between separation setting frame members bordering an exemplary area of superimposed contact pad pairs in illustration of the retention of the elastomer interconnect members in the side by side relationship.

FIGS. 5-7 are partially assembled cross sectional depictions of an exemplary two side by side elastomer interconnect members positioned between separation setting frame members bordering superimposed contact pad pairs in illustration of the interrelated tradeoff considerations in the practice of the invention in which:

FIG. 5 is a cross sectional depiction of a partially assembled cross sectional depiction of the exemplary two side by side elastomer interposer members positioned between separation setting frame members bordering an exemplary area of superimposed contact pad pairs illustrating the positioning of a region of different coefficient thermal expansion (CTE) between each downstop member and the substrate wiring board member;

FIG. 6 is a cross sectional depiction of a partially assembled depiction of the exemplary two side by side elastomer interconnect members positioned between separation setting frame members bordering an exemplary area of superimposed contact pad pairs illustrating the positioning of a region of different coefficient thermal expansion (CTE) between each separation setting frame member and the substrate wiring board; and between the downstop member and the semiconductor chip.

FIG. 7 is a cross sectional depiction of a partially assembled depiction of the exemplary two side by side elastomer interconnect members positioned between separation setting frame members bordering an exemplary area of superimposed contact pad pairs illustrating the positioning of a first region of different coefficient thermal expansion (CTE) between each downstop and the substrate wiring board member; and a second region of different thermal expansion(CTE) between each downstop member and the semiconductor chip.

### DESCRIPTION OF THE INVENTION

Arrays of these types in the art are arranged in modules and in turn in a frame that spatially holds the interconnects. A frame is used with post type chip to printed wiring board separation members with physical downstop members that limit the chip to printed circuit travel. The physical downstops are built into and positioned so that the movement of the superimposed input output pads toward each other is established at a selected proximity at which the designed permanent compression force on the array and the opposing restoring force from the compressed elastomeric interconnects are in operation.

In accordance with the invention some failures in these types of arrays are influenced by relaxation of the restoring force under conditions where a physical dimension change in the interconnect is detrimental. The elastomeric interconnect undergoes a dimensional pullback or shrinkage over time and under temperature change that can affect the magnitude of the restoring force. The restoring force in the elastomeric interconnect material begins to decay with time and with temperature change and if permitted to continue, can reach values as low as 10-20 grams per interconnect member, with the value continuing moving toward zero at an exponentially decreasing rate. The interconnect members are particularly vulnerable under the low restoring force conditions. Failure may occur where there is a temperature drop of a magnitude that can be as minimal as could be produced by turning off the apparatus in which the array is situated.

The shrinkage can result in a stress on the interconnect member that can change from being in compression to being in tension. Once the interconnect member is in tension the only thing that would be maintaining the contact between the, usually gold, contacting layers on the superimposed input output pads, would then be only any intrinsic adhesion that may be present. Under such conditions the interface through the interconnect member becomes highly unstable and prone to failure. If the adhesion fails, a full open circuit can then occur. Even under conditions where the restoring force decays to low values but the interconnect member is still in compression, electrical failures have been observed. A certain minimal compressive force across the interconnect member is needed for reliable operation. The point being advanced is that there are many types of stresses and strains from different directions that can influence the reliability and durability of the electrical properties of the array through the elastomer interconnect members.

In accordance with the invention, control of the effect of a dimension change in elastomer interconnect columns is imparted through including the coefficient of thermal expansion property as a design consideration in construction of LGA interposers; meaning the collective entity of the frame and contacts. The introduction of regions with high (CTE) in the frame introduces a self compensation capability that will be operable to counter such conditions as changes from compression to tension in individual interconnect columns and also to moderate the net effect of the various stresses in such arrays.

Referring to FIG. 1, where there is shown a cross sectional depiction of a single interconnect member of the interface of superimposed input output pads, with the compression and restore forces represented by arrows.

In the interface of FIG. 1 there is a first, mating, input output pad 1, on the contact face 2 of a solid state semiconductor device such as a multi chip module illustrated as a single semiconductor chip 3 which is in an aligned superimposed position with respect to a second mating input output pad 4 on the conductor face 5 of an external circuitry substrate such as a printed wiring board 6. In the interface there is the elastomer interconnect member 7, positioned between the input output pads 1 and 4. A post frame member 8 is provided that is positioned to support a downstop member 9 that is attached to the frame post 8 at surface 10. An overall frame 11, will be made up of frame posts 8 supporting downstops 9 and interconnect member retention members 12 that hold the interconnect members 7 in relative position. The downstops 9 operate to establish the relative position of the chip surface 2 and the printed wiring surface 5 that in turn provides the amount of compression distortion 13, shown as a curved line of the elastomeric interconnect member 7.

In operation there will be a selected compression force, illustrated by the opposing force arrow segments 15a and 15b that operates to bring the chip surface 2 and the substrate surface toward each other, that is opposed by an approximately equal and varying restoration force 16a and b, produced by the compressed elastomeric material of the interconnect column 7.

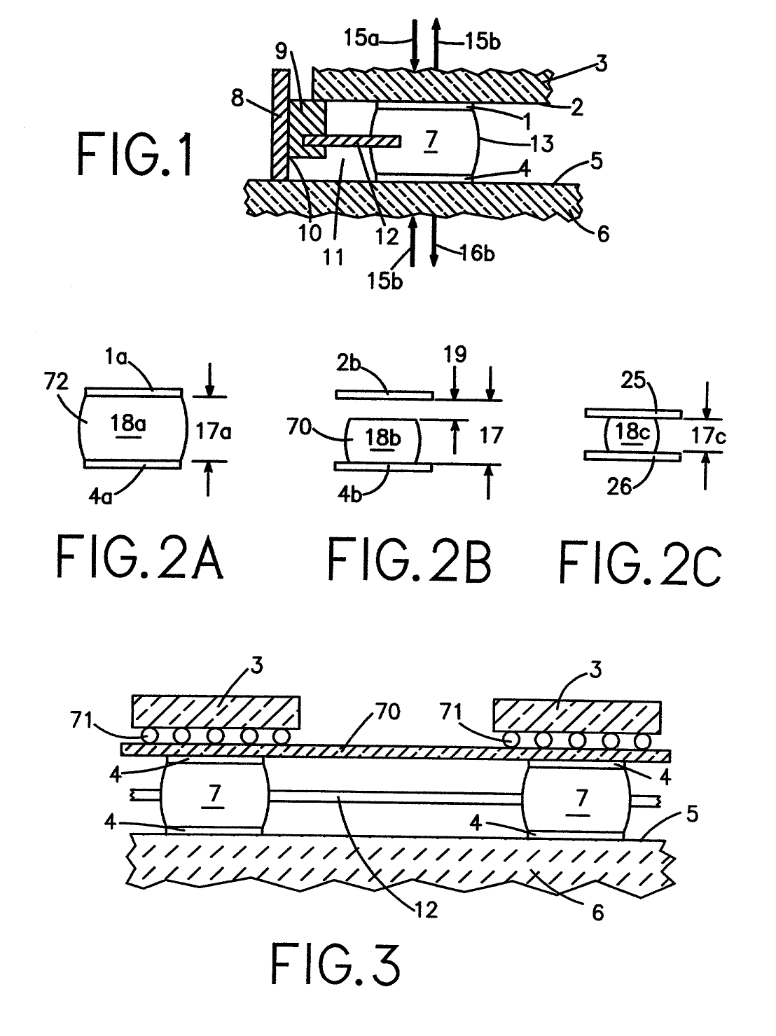

In accordance with the invention the restoration force 16 may exhibit decay and shrink over time and with normal environmental cycling temperature change. The effect on the interface is depicted in FIGS. 2a-2c wherein in FIG. 2a under design and initial conditions, the elastomeric material in the interconnect member 7, at a dimension 17a between pads 1a and 4a exhibits a slight curvature under the opposing forces 15 and 16, and satisfactory electrical contact between pads 1 and 4 is provided. The situation, in the event of a temperature decrease, with an uncompensated frame is depicted in connection with FIG. 2b. The effect of the temperature decrease is that there is a shrinkage of the elastomer 18b in the interconnect member 7b producing a gap 19 with a potential electrical discontinuity between the elastomer 18b and the pad 2b while the dimension 17b remains essentially the same. In accordance with the invention, in FIG. 2c the frame has built into it a favorable (CTE) that operates to provide some compensation for the shrinkage, permitting each pad, 1c and 4c, to move pads 25 and 26 respectively retaining electrical contact with the reduced elastomer 18c to permit the reduction to dimension 17c in compensation for the shrinkage.

In accordance with the invention, the introduction of the (CTE) as a design consideration is achieved by introducing regions of selected (CTE) into the frame.

The preferred elastomer material to be used for the interconnect column 7 is a metal particle filled siloxane material which while the siloxane material itself has a high (CTE) property any downside aspects are still tolerable as an elastomer component.

There are in connection with the frame a number of relatively high (CTE) materials that can have their physical hardness properties modified by filling. As examples of such materials are polymers of polyethylene, polyprophylene, polyurethane and rubber polymers such as polyphosphazine.

Variation of the amount of metal particle filling of an elastomeric siloxane polymer can alter (CTE) but the electrical property requirements of the filling particles must be taken into consideration as they may limit flexibility.

Changes in the differential (CTE) between the elastomer interconnect member and the overall frame can be imparted by making the parts such as elements 7,8 and 9 with higher or lower (CTE) or through the introduction of pads of different (CTE) material into those parts. As a further illustration if downstop 9 were made of, or had, a layer of high(CTE) material, then the susceptibility of column 7 to shrinkage on cooling would be minimized by the properties of 9 which would would operate to close any gap formation between pads 1 and 4 while keeping the restoring force relatively constant. An ideal would be to have the (CTE) of element 9 be higher and the hardness be greater than that of element 7.

In many constructions, advantages are gained by having an intermediate interconnecting interface between the contacts on an integrated circuit chip and the members of the elastomer interconnect assembly. A modular structure is thus produced that also provides fan out capability. The terminology, module, generally involves both the integrated circuit chip interconnection and the modular structure.

The modular structure is illustrated in connection with FIG. 3 wherein like reference numerals are used where appropriate. In FIG. 3 there is a cross sectional depiction of two integrated chips 3 each connected to circuitry, out of view in this illustration, on an intermediate support member 70 of for example ceramic material, through for example typical ball contacts 71. The intermediate support member 70 provides fan in circuitry, out of view, joining the contacts 71 to the pads 4 on a supporting assembly of elastomer interconnect members 7 on a surface 5 of a substrate 6. A retaining capability of the element 12 type is provided with a tructural element such as a resilient Kaplan(™) sheet.

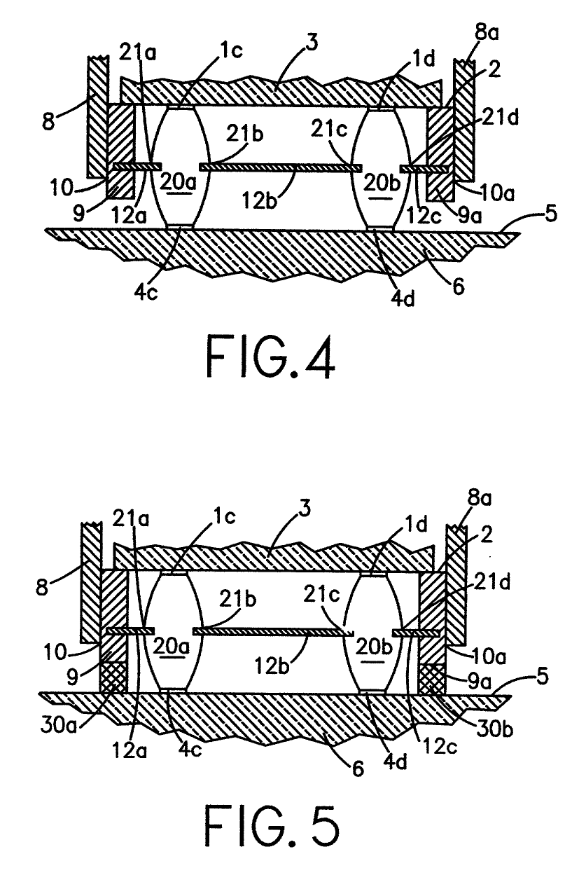

In FIG. 4, where like reference numerals with those of FIG. 1 are used where appropriate, there is shown a cross sectional depiction of a partially assembled exemplary two, side by side, elastomer interconnect member assembly positioned between separation setting frame members bordering an exemplary area of superimposed contact pad pairs in illustration of the retention of the elastomer interconnect members in the side by side relationship using framing members supported by insertion into openings in the frame members and in the interconnect members or by the use of the technique of co-molding with the outer frame. The technique of co-molding is also employed in downstop placement.

In FIG. 4 there are two sets of superimposed input output pads 1c,4c and 1d,4d, between the surface 2 on the integrated circuit chip 3 and the surface 5 of the printed wiring element 6. There are two elastomer interconnect members 20a and 20b, each a counterpart of element 7 of FIG. 1. In elastomer interconnect members 20a and 20b there are openings 21a, 21b, 21c, 21d to accommodate additional elastomer interconnect member retaining members such as is illustrated by elements12a,12b and 12c. The retaining members look like rods in cross section but are sheet materials or thin plastic. The member 12a has one end positioned in an opening in the downstop 9 and extends into the opening 21a in the elastomer interconnect member 20a. The member 12b has one end positioned in the 21b opening in the elastomer interconnect member 20a and the remaining end positioned in the 21c opening in the elastomer interconnect member 20b. The member 12c has one end positioned in the opening in downstop 9a and extends into the opening 21d in the elastomer interconnect member 20a.

In FIGS. 5-7 variations of ways are depicted of compensating for stress through including the (CTE) in the design of the frame structure. Specifically FIGS. 5-7 are partially assembled cross sectional depictions of an exemplary two side by side elastomer interconnect members positioned between post frame members 8 and 8a bordering superimposed contact pad pairs in illustration of the interrelated tradeoff considerations in the practice of the invention.

One tradeoff is based on the fact that the expansion or contraction performance of the member of the structure involved can be affected by building into the member a region or a coating of selected (CTE). The goal being to have a selected thermal response of the member.

Referring to FIGS. 5, 6 and 7 in each there is shown a cross sectional depiction of a partially assembled exemplary two side by side elastomer interconnect members positioned in an exemplary frame environment of the type in FIG. 4.

In FIG. 5, a separate (CTE) region imparting the design performance, is inserted as an independent element into the frame. In FIG. 5 this is illustrated as elements 30a and 30b which extend the downstops 9 and 9a to the substrate surface 5.

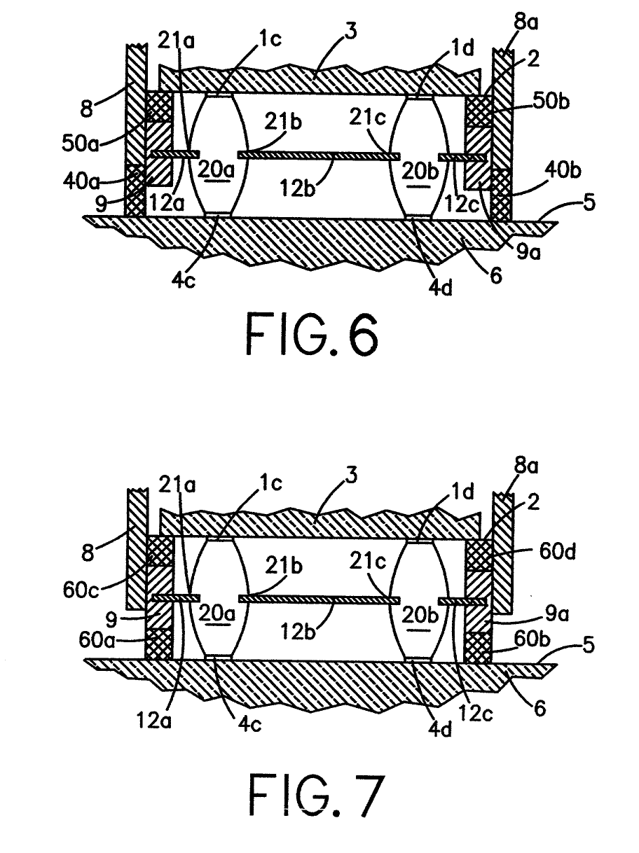

In FIG. 6, separate (CTE) regions imparting the design performance, are inserted as independent elements at different locations into the frame. In FIG. 6 this is illustrated as elements 40a and 40b which extend the posts 8 and 8a to the substrate surface 5 and as elements 60a and 50b positioned between the downstops 9 and 9a to the surface 2 of the chip 3.

In FIG. 7, multiple separate regions imparting through selected (CTE) properties the design performance, are inserted into a single element of the frame. In FIG. 7 this is illustrated as elements 60a and 60b which extend the downstops 9 and 9a to the substrate surface 5 and as elements 60c and 60d which extend the same elements the downstops 9 and 9a, to the surface 2 of the chip 3.

In compensating for the elastomer shrinkage shown in FIG. 2b from dimension 17 to dimension 18 of FIGS. 2b and 2c, in fabrication and service, the dimensional increment or decrement contributed by the (CTE) property of the region of the frame element involved, should be greater than or equal to the product of the overall element dimension 17c and it's (CTE).

Considering as an illustration the situation in FIG. 6, where separate (CTE) regions imparting the design performance, are inserted as independent elements at different locations into the frame, in this situation, elements 40a and 40b which extend the posts 8 and 8a to the substrate surface 5 and elements 50a and 50b positioned between the downstops 9 and 9a to the surface 2 of the chip 3. In this situation the elements 8 and 8a and 9 and 9a are of normal (CTE), normally injection molded plastic. The function of the added regions, 40a and b and 50a and b, of high (CTE) material is to control the gap between pad pairs 1c and 4c and 1d and 4d.

In FIG. 6, the combined thickness, in the dimension between the substrate surface 5 and the surface 2 of the chip 3, times the (CTE) of the materials, of elements 40a and 50a in the 8,9 post downstop combination and elements 40b and 50b in the 8a,9a post downstop combination is arranged to be greater than the column(CTE) ×column height.

Under these conditions, where the high CTE materials of elements 40a and 50a in the high CTE frame material element is labelled “hcfin”, HEIGHT is the distance between substrate surface 5 and chip surface 2 and the height of the elastomer interconnect members 20a and 20b then performance follows the expression of Equation 1 as follows

(CTE)hcfm×(HEIGHT)hcfm>(CTE) interconnect column×(HEIGHT) interconnect column Equation 1

As further examples of tradeoffs if the entire frame itself were made of high (CTE) material rather than just regions such as 30, 40, 50 and 60, the structure would be effective but at the present state of the art materials with good frame properties such as injection moldability and strength while having high (CTE) have not been significantly invesitgated and reported. It is thus advantageous to construct the frame of high (CE) regions separated of the frame functions.

It will be further apparent that if the ideal condition stated in equation 1 cannot be achieved because of unavailability of materials or because of fabrication limitations, there is still an advantage if progress toward that ideal condition can be achieved. Expressed in another way, if the difference in dimensional changes between the gap dimension 19 of FIG. 2b and the overall dimension 17 of the elastomer interconnect member can be reduced relative to what it would be without the compensating frame elements 30, 40, 50 and 60, it would still be highly desirable.

What has been described is the moderating of the various effects of temperature in high density resilient interconnect structure of the LGA type by building into the arrangement a selected thermal expansion property that operates to exert some control on the thermal dimensional aspects of the elastomeric interconnect in fabrication and throughout service.

What is claimed is:

1. In a land grid array type multiple interconnect apparatus wherein a plurality of elastomer interconnect columns simultaneously form connections between module contact pads on a contacting surface of an integrated circuit module and wiring contact pads on a printed wiring board in the presence of a compression force urging the module and wiring pads toward each other and an opposing smaller restore force urging the module and wiring pads apart,
the improvement comprising:
the positioning in the interconnect and frame structure of said array a selectable coefficient of thermal expansion capability operable to compensate for forces operating to produce a dimensional change in said connections.

2. The improvement of claim 1 wherein said selectable coefficient of thermal expansion capability is provided by use of a material with higher coefficient of thermal expansion in a structural part of said array.

3. The improvement of claim 1 wherein said selectable coefficient of thermal expansion capability is provided by positioning in said interconnect and frame structure at least one additional region of at least one material each said region having a coefficient of thermal expansion operable to reduce net thermal at least one of stress and strain in said array.

4. The improvement of claim 3 wherein said at least one region with selectable coefficient of thermal expansion capability is of a material with a higher coefficient of thermal expansion than the material in other structural parts of said array.

5. The improvement of claim 4 wherein said selectable coefficient of thermal expansion capability is provided by positioning in said interconnect and frame structure at least one region of at least one material each said region having a coefficient of thermal expansion operable to reduce net thermal at least one of stress and strain in said array.

6. In a land grid array type of multiple interconnect apparatus wherein a plurality of elastomer interconnect members having a specific diameter and composition simultaneously form connections between module contact pads on a contacting surface of an integrated circuit module and wiring contact pads on a printed wiring board, in the presence of a compression force urging the module and wiring pads toward each other with travel of said module toward said printed wiring board being limited by post members with attached downstop members and an opposing smaller restore force urging said module and wiring pads apart,
the improvement, operable to compensate for dimensional changes to the interconnects that may occur to the array in fabrication and service, comprising:
the positioning in at least one of the said interconnect member, said post and said downstop member structure of said array a selectable coefficient of thermal expansion capability.

7. The improvement of claim 6 wherein said selectable coefficient of thermal expansion capability is provided by positioning in said interconnect and frame structure at least one region of at least one material each said region having a coefficient of thermal expansion operable to reduce net thermal at least one of stress and strain in said array.

8. The improvement of claim 7 wherein said selectable coefficient of thermal expansion capability is at least one region with a material with a higher coefficient of thermal expansion than the material in other structural parts of said array.

9. A process of fabrication of a reduced net thermal at least one of stress and strain in a land grid array of elastomer interconnect members, arranged in a frame structure with posts and attached downstops, that form connections between module contact pads on a contacting surface of an integrated circuit chip and wiring contact pads on a printed wiring board, comprising in combination the steps of:
positioning in each group of said interconnect members, said posts and said downstops at least one region with a material with a higher coefficient of thermal expansion than the material in other structural parts of said array, and,
applying a compression force across the area of said array operable to urge each module and wiring pad toward each other.

10. A process of fabrication of a reduced net thermal at least one of stress and strain in a land grid array of resilient interconnect members, arranged in a frame structure with posts and attached downstops, that form connections between module contact pads on a contacting surface of a module member and wiring contact pads on a printed wiring board, comprising in combination the steps of:
positioning in each group of said interconnect members, said posts and said downstops at least one region with a material operable to produce a higher coefficient of thermal expansion than the material in other structural parts of said array, and,
applying a compression force across the area of said array operable to urge the contacts of each module member and of the wiring pads toward each other.
